(19) United States
(12) Patent Application Publication
(10) Pub. No.: US 2010/0225555 A1
(43) Pub. Date: Sep. 9, 2010

(54) CIRCUIT BOARD FOLDED DIPOLE WITH INTEGRAL BALUN AND TRANSFORMER

(75) Inventor: Robert Charles Gunnels, Homer Glen, IL (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: PC-TEL, Inc., Bloomington, IL (US)

(21) Appl. No.: 12/397,722

(22) Filed: Mar. 4, 2009

(51) Int. Cl. H01Q 1/50

(52) U.S. Cl. 343/859

(57) ABSTRACT

An antenna is described having an RF connection and a second connection. The antenna includes a dielectric panel having a first longitudinal edge and second, opposing longitudinal edge and a first transverse edge and second, opposing transverse edge, a first antenna element disposed on a first predominant surface of the panel, said first antenna element extending along a periphery of the dielectric panel and only along the periphery of the first surface with a second connection located midway along the first longitudinal edge of the board and a gap in the first antenna element located midway along the opposing second longitudinal edge and a second antenna element disposed on a second predominant surface of the panel, said second antenna element extending along the periphery and only along the periphery, said second antenna element electrically connecting with the RF connection located midway along the first longitudinal edge adjacent the second connection and extending along the first longitudinal edge, across the transverse edge and along the second, opposing longitudinal edge to terminate adjacent the gap on a distal end.

### FIELD OF THE INVENTION

The field of the invention relates to wireless communication systems and more particularly to radio frequency antenna for wireless communication systems.

### BACKGROUND OF THE INVENTION

Yagi-Uda antenna are generally known. Yagi-Uda antenna can be used in any of a number of different frequency ranges (e.g., cellular telephone).

Such antenna generally consist of a driven element and one or more parasitic elements. Since the driven element and parasitic element can be arranged in a single plane, the Yagi-Uda antenna is relatively compact and has found broad use in the cellular industry.

One drawback of the Yagi-Uda antenna is that it must be fed in a balanced manner (e.g., from a balanced feedline). A balanced feedline means that neither conductor is connected to ground.

However, balanced feedlines are often difficult to install in such a manner as to maintain balance. Unintended imbalance can result in unintended RF radiation As a result, antenna are typically fed byunbalanced coaxial feedlines. In order to feed the balanced antenna with a coaxial transmission line it is necessary to make a balanced to unbalanced transformation using a structure known as a balun.

While baluns are effective, they can be a challenge to easily construct. Moreover, baluns may take many different forms. For example, a balun could be constructed from a transformer or from a U-shaped tube one-half wavelength long and a length of coaxial cable. In this case, the shield is removed from the coaxial cable to expose the center conductor and insulation for a length of one-half wavelength. The center conductor and shield are inserted into the U-shaped tube. The shield is attached to one end of the U-shaped tube and connections to the center conductor at opposing ends of the U-shaped tube form the balanced line.

While construction of baluns from U-shaped tubes is cost effective, it is often difficult to attach the U-shaped tube to a Yagi-Uda antenna without grounding the antenna. It is also sometimes difficult to make connections with the center conductor within the U-shaped tube without contacting the grounded surface of the U-shaped tube. Accordingly, a need exists for better methods of constructing balun s.

### SUMMARY

An antenna is described having an RF connection and a second connection. The antenna includes a dielectric panel having a first longitudinal edge and second, opposing longitudinal edge and a first transverse edge and second, opposing transverse edge, a first antenna element disposed on a first predominant surface of the panel, said first antenna element extending along a periphery of the dielectric panel and only along the periphery of the first surface with the second connection located midway along the first longitudinal edge of the board and a gap in the first antenna element located midway along the opposing second longitudinal edge and a second antenna element disposed on a second predominant surface of the panel, said second antenna element extending along the periphery and only along the periphery, said second antenna element electrically connecting with the RF connection midway along the first longitudinal edge adjacent the second connection and extending from the RF connection along the first longitudinal edge, across the transverse edge and along the second, opposing longitudinal edge to terminate adjacent the gap on a distal end.

In another aspect of the invention, the antenna includes a dielectric panel, a first antenna loop disposed on a first predominant side of the panel, said first antenna loop extending around a periphery of the dielectric board, said first antenna loop having a gap located midway along a first edge of the panel and the second connection located along an opposing edge of the panel and a second antenna element disposed on an opposing predominant side of the panel, said antenna element extending along the periphery of the panel from a first end adjacent the gap to a second end adjacent the second connection, said second antenna element having an RF connection on the second end.

In another aspect, the antenna includes a dielectric panel having a pair of parallel longitudinal edges and a pair of parallel transverse edges, a first antenna element disposed on a first predominant surface of the dielectric panel and extending from an RF connection located midpoint along a first longitudinal edge of the pair of longitudinal edges to a first end of the first longitudinal edge, across a first transverse edge of the pair of transverse edges and from a first end of a second longitudinal edge of the pair of longitudinal edges to a midpoint of the second longitudinal edge and a second antenna element disposed on an opposing, second predominant surface of the dielectric panel and extending along a periphery of the dielectric panel along the first and second pairs of edges said second antenna having the second connection midway along the first longitudinal edge and a gap located midway along the second longitudinal edge.

### BRIEF DESCRIPTION OF THE DRAWINGS

FIG. 1 is a block diagram of a RF transmission and receiving system in accordance with an illustrated embodiment of the invention;

FIGS. 2a-c are front, edge and back views of an antenna element that may be used with the antenna system of FIG. 1; and

FIG. 3 is a graph of return loss versus frequency for the antenna of FIG. 2 over a frequency range of from 902 to 928 MHz.

### DETAILED DESCRIPTION OF AN ILLUSTRATED EMBODIMENT

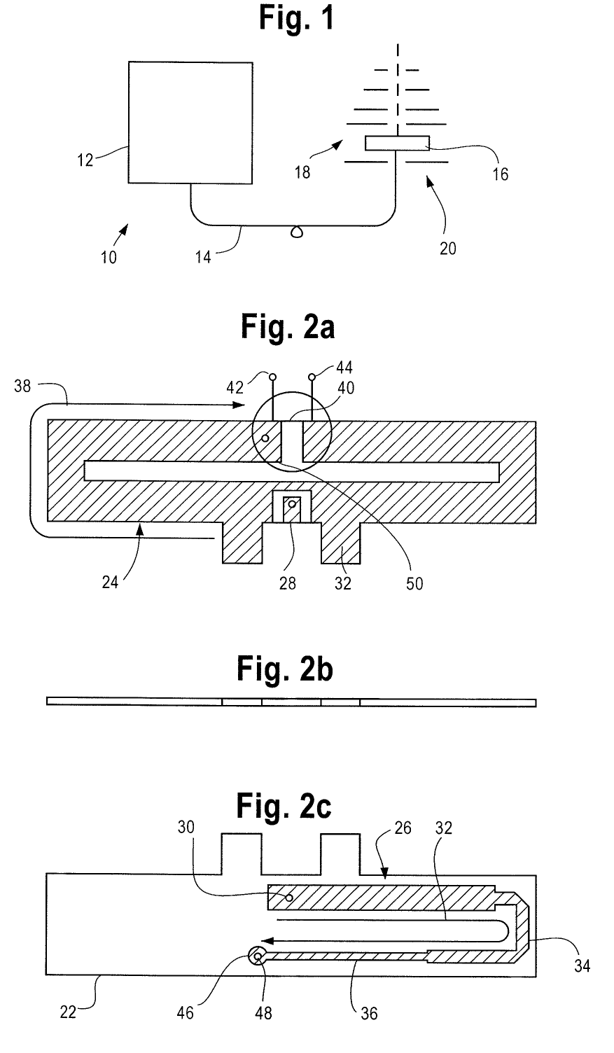

FIG. 1 is a block diagram of a radio frequency (RF) transmission system 10 shown generally in accordance with an illustrated embodiment of the invention. The transmission system 10 may be provided for use in conjunction with a base station, satellite or other mobile station for any appropriate wireless use (e.g., cellular telephone, PDA, etc.).

Included within the system 10 is an RF source 12 providing an RF signal (modulated with an information signal), a coaxial connection cable 14 and an antenna assembly 20. The antenna assembly 20 may use the antenna element 16 by itself to transceiver an RF signal or a balun of the antenna element 16 may be connected to an antenna 18 and used as part of a Yagi-Uda array.

FIG. 2a-c are a front, edge and back views of the antenna element 16. FIG. 2a shows a folded dipole 24 located on a first predominant side of the substrate 22 and FIG. 2c shows a balun 26 located on a second, opposing predominant side of the substrate 22. The balun 26 and folded dipole 24 operate in conjunction to provide a functionality not available through other similar devices.

The antenna assembly 20 may be fed from an unbalanced feed line. For example, the center conductor of the coaxial cable may be connected to a RF connection (terminal) 28. The shield of the coaxial conductor (which may be grounded) may be connected to a center point (terminal) 32 of the folded dipole 24.

The RF connection 28 has a feedthrough hole 30 that electrically connects the RF connection 28 to a proximal end of the balun 26. The balun 26 has an electrical length 32 of approximately one-half wavelength.

The balun 26 may also include one or more impedance transformers 34, 36. As would be known to those of skill in the art, the use of the two or more impedance transformers 34, 36 functions to expand a bandwidth of the antenna 16. The impedance transformers 34, 36 may be implemented as one-quarter wavelength sections divided by step reductions in width as shown in FIG. 2c or the impedance transformers may implemented as one-quarter wavelength sections with gradual reductions in width depending upon the bandwidth requirement of the antenna 16.

As shown in FIG. 2a, the folded dipole 24 is disposed on the first predominant surface of the dielectric panel or substrate 22 and extends around a periphery of the dielectric panel 22 and only around the periphery. The folded dipole 24 is substantially continuous around the periphery except for a gap 40. The gap 40 of the folded dipole 24 is disposed on the first predominant side of the substrate 22 along the edge of the panel 22 opposite the ground connection and divides the folded dipole into first and second portions on either side of a line between the gap 40 and ground connection. The electrical length 38 of the first and second portions of the folded dipole 24 between the ground connection and gap 40 is substantially equal to one-half wavelength.

It should be specifically noted that the driving points 42, 44 of the folded dipole 24 are on opposing sides of the gap 40. The connection points 42, 44, in fact, form balanced terminals for connection to (and for driving) the antenna 18.

It should also be noted that opposing sides of the gap 40 also provide a feed point for the dipole antenna 24 from the balun 26. In this regard, a through hole 48 on a distal end of the balun 26 may be used to provide a direct electrical connection to a first side 50 of the gap 40. The balun 26 may also be capacitively coupled to the second, opposing side 50 of the gap 40.

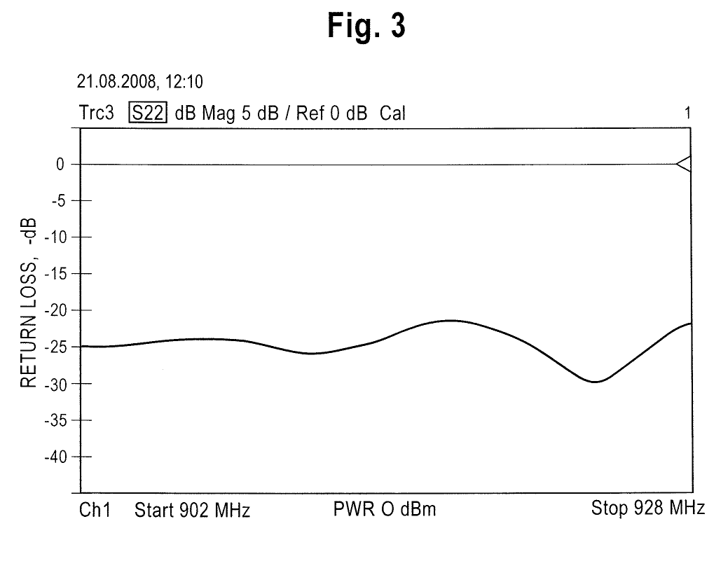

FIG. 3 is a graph of return loss versus frequency. As can be seen from FIG. 3, the return loss remains above 22 dB over the frequency range of from 902 to 928 MHz.

The antenna element 16 offers significant advantages over other antenna elements. On a first level, a user of antenna element 16 can connect the antenna element 16 directly to an unbalanced RF feed line since the antenna element has its own integral balun 26. On another level, the antenna element 16 can be combined with other elements or structure to enhance radiation. In this case, the balanced feed terminals 42, 44 can be used to couple RF to other antenna structures.

On another level, the antenna element 16 is compact and easy to manufacture since it is constructed of a dielectric substrate (e.g., FR-4) with copper traces on each side. On still another level, the flat structure of the antenna element 16 allows the element 16 to be easily enclosed by an insulating radome that not only protects the connections from weather and corrosion.

A specific embodiment of an antenna element has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. An antenna having an RF connection and a second connection, said antenna element comprising:
a dielectric panel having a first longitudinal edge and second, opposing longitudinal edge and a first transverse edge and second, opposing transverse edge;
a first antenna element disposed on a first predominant surface of the panel, said first antenna element extending along a periphery of the dielectric panel and only along the periphery of the first surface with a second connection located midway along the first longitudinal edge of the board and a gap in the first antenna element located midway along the opposing second longitudinal edge;
a second antenna element disposed on a second predominant surface of the panel and electrically isolated from the first antenna element, said second antenna element extending along the periphery and only along the periphery, said second antenna element electrically connecting on a proximal end with the RF connection located midway along the first longitudinal edge adjacent the second connection and extending along the first longitudinal edge, across the first transverse edge and along the second, opposing longitudinal edge to terminate adjacent the gap on a distal end.

2. The antenna as in claim 1 wherein the second antenna element further comprises an electrical length of one-quarter wavelength along each longitudinal edge.

3. The antenna as in claim 1 further comprising a shorting connection between the distal end of the second antenna element and the first antenna element on a side of the gap realtively nearest the second, opposing transverse edge.

4. The antenna as in claim 1 wherein the RF connection further comprising a coaxial cable.

5. The antenna as in claim 1 further comprising a Yagi-Uda antenna array connected to the distal end of the first and second antenna.

6. The antenna as in claim 1 further comprising an impedance transformer disposed in series the second antenna element.

7. An antenna comprising:
a dielectric panel;
a first antenna loop disposed on a first predominant side of the panel, said first antenna loop extending around a periphery of the dielectric board, said first antenna loop having a gap located midway along a first edge of the panel and a second connection located along an opposing edge on the first predominant side of the panel; and
a second antenna element disposed on an opposing predominant side of the panel, said antenna element extending along the periphery of the panel from a first end of the second antenna element adjacent the gap to a second end adjacent the second connection, said second antenna element having an RF connection on the second end.

8. The antenna as in claim 7 wherein the dielectric panel further comprises a rectangular shape where a relative length of the first edge is greater than a length of an adjacent edge.

9. The antenna as in claim 8 wherein the second antenna element further comprises an electrical length of one-quarter wavelength along each of the first and opposing edges.

10. The antenna as in claim 7 further comprising a shorting connection between the first end of the second antenna element and the first antenna element on a side of the gap realtively nearest an opposing end of the panel.

11. The antenna as in claim 7 wherein the RF connection further comprising a coaxial cable.

12. The antenna as in claim 7 further comprising a Yagi-Uda antenna array connected to the first end of the second antenna.

13. The antenna as in claim 7 further comprising an impedance transformer disposed in series the second antenna element.

14. An antenna comprising:
a dielectric panel having a pair of parallel longitudinal edges and a pair of parallel transverse edges;
a first antenna element disposed on a first predominant surface of the dielectric panel and extending from an RF connection located midpoint along a first longitudinal edge of the pair of longitudinal edges to a first end of the first longitudinal edge, across a first transverse edge of the pair of transverse edges and from a first end of a second longitudinal edge of the pair of longitudinal edges to a midpoint of the second longitudinal edge; and
a second antenna element disposed on an opposing, second predominant surface of the dielectric panel and extending along a periphery of the dielectric panel along the first and second pairs of edges said second antenna having a second connection midway along the first longitudinal edge and a gap located midway along the second longitudinal edge.

15. The antenna as in claim 14 wherein the first antenna element further comprises an electrical length of one-quarter wavelength along each longitudinal edge.

16. The antenna as in claim 14 further comprising a shorting connection between the first and second antenna elements located at the midpoint of the second longitudinal edge.

17. The antenna as in claim 14 wherein the RF connection further comprising a coaxial cable.

18. The antenna as in claim 14 further comprising a Yagi-Uda antenna array connected to the distal end of the second antenna.

19. The antenna as in claim 14 further comprising an impedance transformer disposed in series the second antenna element.

20. The antenna as in claim 14 wherein the pair of longitudinal and transverse edges further comprise respective equal lengths.
